(19) United States
(12) Patent Application Publication
(10) Pub. No.: US 2021/0169120 A1
(43) Pub. Date: Jun. 10, 2021

(54) AUTOMATED FOOD PREPARATION AND PACKAGING SYSTEMS, METHODS, AND APPARATUS

(71) Applicant: West Liberty Foods, L.L.C., West Liberty, IA (US)

(72) Inventors: Ed Claussen, West Liberty, IA (US); Gerald Lessard, West Liberty, IA (US)

(21) Appl. No.: 17/247,236

(22) Filed: Dec. 4, 2020

Related U.S. Application Data
(60) Provisional application No. 62/943,394, filed on Dec. 4, 2019.

(51) Int. Cl. A23P 20/20; A21C 15/00; B65B 57/14; B65B 61/20; B25J 11/00; G05B 19/4155

(52) U.S. Cl. CPC A23P 20/20; A21C 15/002; B65B 57/14; B25J 9/0093; B25J 11/0045; G05B 19/4155; B65B 61/20

(57) ABSTRACT

The automated assembly and manufacture of a submarine sandwich includes a number of robots that are used to slice, open, and add inputs to a roll of bread. The inputs may be sliced and portioned at individual stations and then the inputs can be delivered to the bread or the bread can be conveyed to the inputs. In either sense, the selected inputs are added to the bread, based on the type of sandwich to be assembled. The assembled sandwich is then conveyed to a packaging station, where the sandwich is packaged, labeled, and prepared for shipment.

### CROSS REFERENCE TO RELATED APPLICATIONS

This application claims priority under 35 U.S.C. § 119 to provisional patent application U.S. Ser. No. 62/943,394, filed Dec. 4, 2019. The provisional patent application is herein incorporated by reference in its entirety, including without limitation, the specification, claims, and abstract, as well as any figures, tables, appendices, or drawings thereof.

### FIELD OF THE INVENTION

The invention relates generally to systems, apparatus, and/or methods for the automated assembly and/or manufacture of a food product. More particularly, but not exclusively, the invention relates to the automated preparation of a sandwich, such as a hoagie style sandwich.

### BACKGROUND OF THE INVENTION

Sandwiches can be premade and packaged for delivery to a location for sale. For example, sandwiches can be assembled and packaged at one location, and then delivered, in bulk, to a retail center, where the premade sandwiches are sold. The premade sandwiches are easy for consumers to identify and select, such as based upon toppings, inputs, make-up, or the like, and the consumers still have some ability to customize before eating. The types of sandwiches can include, but are not limited to, sandwiches created with sliced bread, such as Pullman loafs, tea sandwiches, or hoagie style sandwiches.

With sliced bread sandwiches, the sandwiches are formed with two relatively flat bread pieces, and inputs or toppings added therebetween. As the bread is flat and easy to add to, making the sandwiches is relatively easy to do. However, to assemble sandwiches of this kind in bulk, an assembly line or other process involving multiple people is generally used to add to the sandwich and then to send to packaging and delivery.

Hoagie style sandwiches are generally made from long, split roll of bread, and include toppings, ingredients, or other inputs positioned generally in the area of the split between portions of the roll. The geometry and orientation of the split roll make it more difficult and time consuming to make a sandwich with such a bread. For example, the sandwich may be made along an assembly line where workers physically add the inputs to a split roll and then move the sandwich to packaging for further labeling, sealing, and delivery to an end location, such as a retail location.

As the assembly line style of creating sandwiches requires multiple people acting in concert, it may be beneficial to automate the process. However, as the different types of bread require different steps for aligning and adding inputs, it is difficult to obtain uniform results. This is further noticed for hoagie style sandwiches, where the bread may not provide an ideal orientation for adding inputs thereto. This is especially true when different types of sandwiches including different inputs are made and packaged. It may be necessary to swap out all of the inputs to so as to mitigate cross-contamination or to mitigate the incorrect input being added.

Therefore, there is a need in the art for a new and/or improved system, method, and/or apparatus for the automated bulk preparation and packaging of sandwiches, and in particular, hoagie style sandwiches.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

Therefore, it is a primary object, feature, and/or advantage of the invention to improve on or overcome the deficiencies in the art.

It is still yet a further object, feature, and/or advantage to provide an automated sandwich method, system, and/or apparatus for creating and/or assembly sandwiches on a line-run basis by adding the components of the sandwich.

It is still yet a further object, feature, and/or advantage to fully automate the sandwich making to reduce labor costs and increase efficiency and uniformity.

It is still yet a further object, feature, and/or advantage to provide a safe, cost effective, and uniform assembly line for automating sandwich assembly and packaging.

It is still yet a further object, feature, and/or advantage to assembly sandwiches in a bulk manner using an automated line.

It is yet another object, feature, and/or advantage to allow for selective addition of components to create variable sandwiches with a single line.

It is still another object, feature, and/or advantage to package, label, and prepare for shipping a bulk load of sandwiches in an automated manner.

These and/or other objects, features, advantages, aspects, and/or embodiments will become apparent to those skilled in the art after reviewing the following brief and detailed descriptions of the drawings.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 is a schematic of an automated assembly line for the preparation and assembly of a hoagie style sandwich according to aspects of the disclosure.

FIG. 2 is another schematic of an automated assembly line for the preparation and assembly of a hoagie style sandwich according to aspects of the disclosure.

An artisan of ordinary skill need not view, within isolated figure(s), the near infinite number of distinct permutations of features described in the following detailed description to facilitate an understanding of the invention.

### DETAILED DESCRIPTION OF THE INVENTION

### Definitions—Introductory Matters

The following definitions and introductory matters are provided to facilitate an understanding of the invention. Unless defined otherwise, all technical and scientific terms used herein have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “invention” or “present invention” as used herein are not intended to refer to any single embodiment of the particular invention but encompass all possible embodiments as described in the specification and the claims.

The term “substantially” refers to a great or significant extent. “Substantially” can thus refer to a plurality, majority, and/or a supermajority of said quantifiable variable, given proper context.

The term “generally” encompasses both “about” and “substantially.”

The term “about” as used herein refers to slight variations in numerical quantities with respect to any quantifiable variable. One of ordinary skill in the art will recognize inadvertent error can occur, for example, through use of typical measuring techniques or equipment or from differences in the manufacture, source, or purity of components. The claims include equivalents to the quantities whether or not modified by the term “about.”

The term “configured” describes an apparatus, system, or other structure that is constructed to perform or capable of performing a particular task or to adopt a particular configuration. The term “configured” can be used interchangeably with other similar phrases such as constructed, arranged, adapted, manufactured, and the like.

Terms characterizing a sequential order (e.g., first, second, etc.), a position (e.g., top, bottom, lateral, medial, forward, aft, etc.), and/or an orientation (e.g., width, length, depth, thickness, vertical, horizontal, etc.) are referenced according to the views presented. Unless context indicates otherwise, these terms are not limiting. The physical configuration of an object or combination of objects may change without departing from the scope of the invention.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

Aspects of the invention relate to the creation, assembly, preparation, and/or building of a sandwich, such as a submarine sandwich. A submarine sandwich, also known as a sub, hoagie, hero, or grinder, is a type of sandwich comprising a length of bread or roll split lengthwise and filled with a variety of meats, cheeses, vegetables, and condiments. In addition, it is to be appreciated that the sandwich may be known as additional names. The particular name of a sandwich should not be limiting on the invention, and instead, it should be appreciated that any sandwich comprising a split piece of bread and filled therein may be considered part of the disclosure.

Sandwiches are a popular type of food, taken to work, school, or picnics to be eaten as part of a packed lunch, dinner, or generally any time. The bread may be plain or be coated with condiments, such as mayonnaise or mustard, to enhance its flavor and texture. As well as being homemade, sandwiches are also widely sold in restaurants and retail locations and can be served hot or cold.

Retail locations that sell premade sandwiches offer a convenience for consumers in that the sandwich is already assembled, can include a variety of meats, cheeses, condiments, or other components that can be easily viewed to choose based upon the same, and can be customized to add condiments that are packaged with the bread, meat, cheese, and/or vegetables to a user's taste. The packaging and labeling of premade sandwiches provide a quick and easy manner for consumers to peruse options and to choose a particular sandwich type that matches their wants at that time. The packaging can also provide a manner to maintain a premade sandwich for a longer shelf-life than a sandwich that is made at home or at a restaurant, such as by reducing the amount of oxygen that the sandwich is exposed to prior to consumption.

To assemble and package submarine sandwiches in such a premade manner, assembly line style systems can be used, wherein workers move bread from a stack of bread to a slicing station and then continued on to add components, by hand, until complete for a particular type of sandwich. The finished sandwiched is then packaged, such as with condiments, napkins, utensils, or the like, labeled, and prepared for shipping to an end location, such as a retail location.

As the by-hand method of assembling sandwiches is inefficient, requires a large workforce, and may not produce uniform sandwiches, aspects of the present disclosure provide for systems, methods, and/or apparatus to automate the assembly and packaging of the submarine sandwiches intended for retail locations or direct to consumers.

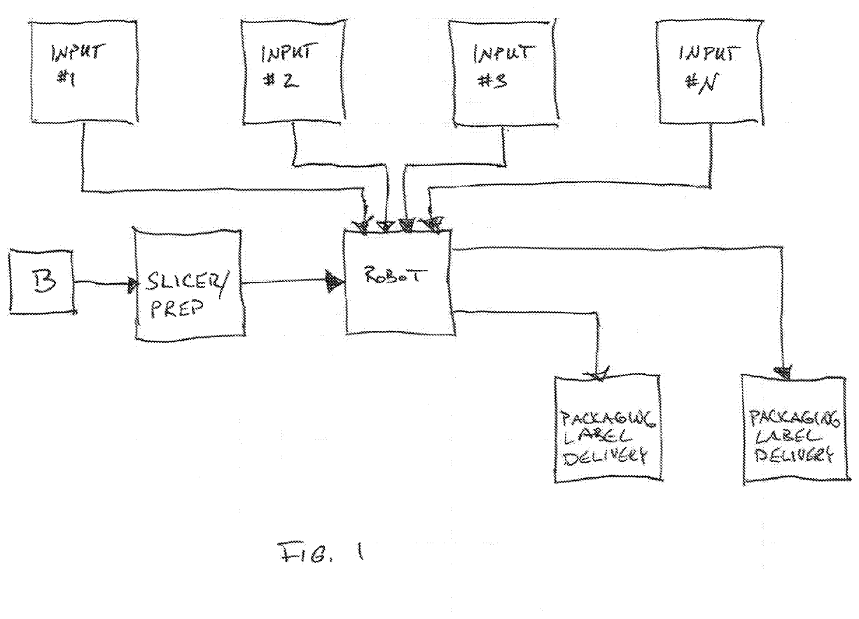

One exemplary system is shown in the schematic of FIG. 1, which shows an abbreviated and exemplary automated sandwich assembly and packaging line, according to aspects and/or embodiments of the invention. As will be understood, the line is automated in that one or more robots handle the assembly of the different sandwich types to be packaged for delivery, such as in bulk, to an end location, such as a retail location.

The automated line shown in FIG. 1 includes a bread rack, shown by the box B. The bread rack can include rolls of bread that will be used to create and assemble the submarine sandwiches. The rolls of bread are added to a conveyor, such as by way of a platen, pin conveyor, or other similar conveyor, moving on a conveying mechanism and is transported to a mechanism for slicing/slitting the bread and opening the roll to prepare the roll for accepting meat, cheese, vegetables, condiments, or the like. For purposes of the present disclosure, any and all types of meats, cheeses, vegetables, toppings, and/or condiments may be referred generically as inputs or components of the sandwich. The slicer may be any machine capable of slicing and opening a roll of bread. For example, according to at least some aspects and/or embodiments of the disclosure, an ultrasonic slicer is used to slice the bread as disclosed.

It should be appreciated that the bread can be sliced in a number of ways. For example, the sub-style bread rolls can be cut in half such that there are two, separate pieces of the roll that are used to create the sandwich. Furthermore, the slicing can be done in a manner in which a portion of the roll is still intact to create a living hinge of the bread, such that portions of the roll are connected. Therefore, the processes, systems, and/or apparatus according to any of the embodiments and aspects, as explicitly disclosed or obvious to those skilled in the art upon a reading of the present disclosure, should be contemplated and understood to accommodate hinged and unhinged bread. In other words, the top and bottom of the bread can be separate or attached. However, according to at least some aspects and/or embodiments, the slicer cuts the bread in a horizontal manner that separates the bread into a top a bottom portion of a sandwich.

The sliced and opened bread from the SLICER/PREP robot is moved toward an assembly robot, which is located at the box labeled “ROBOT” in FIG. 1. As will be understood, the ROBOT of FIG. 1 is a centralized location that will receive one or more inputs to add to the sliced and opened bread, wherein the one or more inputs will be added to assemble a sandwich according to one of a plurality of sandwich types. The sandwich types are indicative of the ingredients, which are preset by the inputs that are added to a particular roll or rolls. Therefore, it should be appreciated that the inputs may also refer to the ingredients, toppings, meats, cheeses, vegetables, fruits, or the like, which are added to the bread to create the varying types of sandwiches.

The ROBOT of FIG. 1 is an automated system that is used to pick and place one or more inputs to the roll. The inputs, as will be understood, are delivered to a location at or near the robot, where a component of the ROBOT is used to selectively choose and place the inputs to the opened rolls until a desired sandwich type has been assembled.

According to some embodiments, the ROBOT of FIG. 1 may be a Weber PickRobot, manufactured by Weber Maschinenbau GmbH, Guenther-Weber-Str. 3 35236 Breidenbach, Germany, although or similar types or robots are intended to be considered a part of the disclosure. Such a robot provides automation for the movement of materials, such as the components of a submarine sandwich. The ROBOT, such as the PickRobot as disclosed herein, includes one or more end effectors that are able to selectively grab or pick an input and to move the input to a location adjacent the opened roll to add the input to the roll. This is continued with the one or more inputs for a particular sandwich type, such as until the sandwich is assembled with the desired inputs.

The inputs are provided to the ROBOT, such as shown in FIG. 1. For example, FIG. 1 shows a plurality of inputs, INPUT 1, INPUT 2, INPUT 3, and INPUT N, wherein INPUT N refers to any final number of inputs desired for a particular sandwich, and is indicative of any number greater than three for the amount of inputs that could be added for different sandwich types. As disclosed, the inputs refer to different components of a sandwich, and can include, but are not limited to, meats, cheeses, vegetables, fruits, condiments, utensils, napkins, add-ins, or the like that may be included with a pre-packaged submarine sandwich.

According to an exemplary example, and for purposes of disclosure, the inputs may relate to a particular type of sandwich, such as a Chicken Bacon Ranch Sub. For such a sandwich, INPUT 1 may be sliced or chopped chicken, INPUT 2 may be bacon, INPUT 3 may be cheese, and INPUT N be another type of meat, vegetable, fruit, or the like. Each of the inputs may be a type of robot that is used to prepare the particular input. For example, INPUT 1 may be a slicing robot that is used to slice and group an amount of chicken, INPUT 2 a slicing or grouping robot for accumulating an amount of bacon, and INPUT 3 another slicing and grouping robot for accumulating an amount of cheese. The accumulated inputs can be added to a plate or other conveyance member. The conveyance member is then directed towards the ROBOT, such as by the arrows in FIG. 1.

The collective input stations can include slicing members for slicing a bulk input, such as a bulk piece of meat or cheese. The sliced input can then utilize an automated loading robot, such as a SmartLoader from Weber Maschinenbau GmbH, which is a fully automatic side loading system for delivering desired portions. However, it should be appreciated that other types of loading systems, slicers, portioners, manufacturers, and the like could be used with the system as shown in FIG. 1.

The arrows are indicative of a conveying member for moving the inputs from their respective locations towards the ROBOT for adding to a roll to create a sandwich. According to some embodiments, the arrows are indicative of magnetic driven platen conveyors. A platen may be used to receive an amount of the input until such platen is filled with said desired amount. This may be a single stack of input, or multiple stacks of inputs from a single input location. Furthermore, the platen may be moved along the conveyor to sequentially receive amounts of inputs from each of the input stations before moving towards the ROBOT for sandwich assembly.

According to additional or alternative embodiments, the system may utilize one or more pin conveyors to move the components of the sandwich through the system, such as to the robot and beyond. This includes a finished sandwich being moved via the pin conveyor to a packaging location.

In any sense, amounts of inputs are delivered or otherwise conveyed from the input stations to a location adjacent the ROBOT by means of the conveyor. While FIG. 1 shows the arrows being one-way from the input stations to the ROBOT, it should be appreciated that the arrows may form a continuous loop that moves adjacent all of the input stations and the ROBOT, wherein a platen moving along the conveyor passes each of the input stations and the ROBOT, and selectively stops by one or more of the input stations and the ROBOT to deliver one or more of the inputs to the ROBOT for sandwich assembly. In addition, the conveyors may be bi-directional in that once an input has been moved to the ROBOT, an empty tray could be returned to the input location for refilling.

According to some aspects of the invention, a Weber ShuttleSystem, manufactured by Weber Maschinenbau GmbH, can be used to move the inputs from the slicing and/or portioning stations towards the ROBOT for sandwich assembly. However, it should be appreciated that other types of conveyors are to be considered as part of the invention and capable of being used.

For example, in the Chicken Bacon Ranch Sub example, a platen or other conveyor, such as a pin conveyor, may receive a stack of inputs from each of the input stations as described herein. The inputs are sliced and placed onto the platens. The platens will travel to each slicer/input station and receive the specific component for the sandwich. Once all the components of the sandwich are on the platen, the platen will travel to the ROBOT station and the portion(s) will be loaded onto the bread. The platen is then moved along the conveyor toward the ROBOT. The pick and place robot at the ROBOT station utilizes an end effector to essentially grab or pick the stacks of inputs in a desired order to assemble the sandwich. For example, the ROBOT may first grab and place an amount of chicken, then an amount of cheese, and then an amount of bacon (or some other order) to create the Chicken Bacon Ranch Sub. Once assembled, the filled roll is then moved along another conveyor to and through one or more of a closing, cutting, and/or single station, wherein the bread roll is closed upon itself, cut into multiple pieces (if desired), or left as a single roll. The assembled sandwich is then continued along a conveyor, such as a magnetically driven conveyor, towards and to a packaging station.

At the packaging station, the sandwich is added to packaging. For example, another robot, such as a pick robot, may be positioned at the packaging station to place the sandwich into a packaging, such as a preformed pocket. In some embodiments, condiments, napkins, utensils, add-ins (toys, advertisements, coupons, information, or the like) may also be added in the packaging by the pick robot. The packaging is then gas flushed, sealed, labeled, and prepared for shipment to an end location, such as a retail location, warehouse, or delivery mechanism. Once packaged, the finished, packaged sandwich can be moved into an area for boxing and shipping to a final destination. It should also be appreciated that any orientation could be done by the pick robot at the packaging, such as rotating any of the assembled sandwiches, as needed, to be placed into the packaging. Once packaged, the sandwiches can then be placed into a container or other vessel for shipping to another location, such as a retail location for sale, a storage location, or a transportation vessel.

As noted, the preparation of the sandwich from the bread rack to the addition of inputs to the assembly of the sandwich to the movement of all components and the packaging is done in an automated manner. The automation of the sandwich assembly and packaging provides a uniform and efficient manner for bulk-producing a variety of types of submarine sandwiches. The addition of the various input stations also allows for a number of different types of sandwiches to be created, based upon the different inputs that can be added to the split rolls.

Furthermore, a control (processor), memory, algorithm, and/or other components that are not shown in the figure are included to control the automation. For example, the system may be programmed to assemble one or a plurality types of sandwiches comprising various inputs. The control and/or algorithm will control the components of the system to ensure that the appropriate inputs are included per the type of sandwich to be made and will continue to do so until manually changed or a threshold is met, such as an number of sandwiches for an order.

Additional components may also be included with the system, such as that shown in FIG. 1. For example, according to some aspects and/or embodiments, a sensor may be included, such as between the ROBOT and the packaging stations, which determine if the assembled sandwich complies with standards. If an improper input is included or omitted, or if one or more of the inputs is not properly aligned, the sensor can flag or otherwise indicate that the sandwich is non-compliant, which will “reject” the sandwich. Any “rejected” sandwich can be directed towards a separate path on the pin conveyor to a location that bypasses the packaging. The “rejected” sandwich can be rectified and replaced on the pin conveyor, such as after the ROBOT, to be directed towards the automated packaging systems.

Other quality assurance sensors and/or systems could be included throughout the path to make sure that the instructed sandwich complies with the inputs, standards, dimensions, and the like, to make sure that any sandwich made by the automated system meets certain standards. If a sensor determines that a standard is not met, the sandwich can be diverted so that it does not pass to the packaging until such time that any defect is corrected. Still further, if a sandwich is too much out of compliance, it can simply be redirected towards a trash or furnace for disposal.

While an ultrasonic slicer has been disclosed, it should also be appreciated that other types of slicers be used to open or halve the bread, and the ultrasonic slicer be used for different purposes. For example, according to some aspects and/or embodiments of the present disclosure, an ultrasonic slicer could be used, such as after the sandwich as been assembled, to cut the assembled sandwich perpendicular to the longitudinal length of the bread. The slicer could be used to cut a single, assembled sandwich into multiple, smaller sandwiches. For example, a 12-inch piece of bread could be used to create the assembled submarine sandwich. The ultrasonic slicer could be used after the sandwich has been assembled to cut the 12-inch sandwich into two, 6-inch sandwiches. This can be done after assembly and before packaging.

Still additional components of the system can include redirecting robots. The conveyors, whether platens, pin conveyors, or otherwise, can be substantially linear or could include bends, turns, or the like to redirect the movement of the components. However, in some instances, it may be preferred to provide re-orientation of the sandwiches, or any portions thereof. Therefore, rotational systems can be included in-line with the conveyors of the system to re-orient the sandwiches. According to some embodiments, the orientation may be a 90-degree rotation of the sandwich before continuing the movement thereof. In other aspects, a 180-degree orientation may be desired before a next step of the system. For example, a robot may rotate the sandwich 180-degrees before it is placed in a packaging.

Still even further, the system may include duplicate robots throughout the system. For example, multiple slicers, pick robots, sensors, rotators, and/or packaging robots may be included to handle a larger number of sandwiches being assembled via the automated system as shown and/or described. This will allow for a high quantity of sandwiches to be assembled and/or packaged for delivery to an end location.

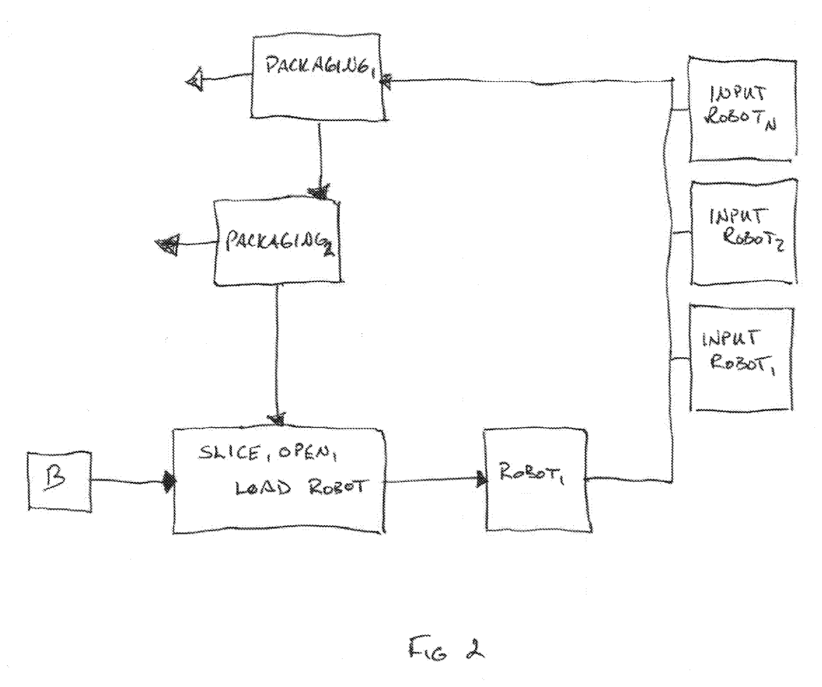

FIG. 2 provides yet another system for the automated manufacturing and/or assembling of a submarine sandwich. The components of FIG. 2 are similar to those as shown and described with respect to FIG. 1. For example, there is shown to be a bread rack B, a slice and open robot. There are also shown to be a number of input robots or stations, ROBOT1, INPUT ROBOT1, INPUT ROBOT 2, and INPUT ROBOT N, where N indicates any number of potential robot stations.

Similar to FIG. 1, the input robot stations are stations where inputs, such as meats, cheeses, vegetables, fruits, or the like, are sliced, portioned, and prepared to be added to an opened roll for sandwich assembly. However, according to the embodiment of FIG. 2, the inputs are not delivered to a main loading robot, and instead, each station includes a robot, such as the pick robot disclosed herein, and the opened bread roll is moved along a conveyor adjacent each of the input stations to selectively add one or more of the inputs to the bread to assemble and/or manufacture a submarine sandwich.

The lines/arrows of FIG. 2 refer to the conveyor, which may be the type as shown and/or disclosed herein. The sliced and opened roll is added to a platen that is moved along the conveyor from the slicer towards the ROBOT 1, where an algorithm determines if an input or action needs to be added or completed at the station. For example, a condiment or input may be added at ROBOT 1. After completion, the platen is then continued along the conveyor towards the INPUT ROBOT 1 station. Again, controls or an algorithm determine (1) if the input(s) of the station should be added and if so, (2) how much. The robot may be a side loader or pick robot or other type of additive robot to add the input to the opened roll. The platen with the roll is then continued to the stations of INPUT ROBOT 2 and INPUT ROBOT N, wherein the controls will determine if any additional inputs should be added, such as based upon the type of sandwich being assembled at a given time. The number of stations and/or stops depend on the type of sandwich and its ingredients.

The completed/assembled sandwich may then be moved towards one or more packaging robots for packaging, labeling, and preparing the assembled sandwiches for delivery. The platen, which is now empty, is then moved back towards the bread for receiving a new portion of bread to assemble another sandwich.

It should be noted that the controls are not shown in the figure, but are to be contemplated as including any instructions, algorithm, or other controls needed. For example, as the system is automated, it may include any number of modules, programs, processors, memory, operating systems, databases, power sources, user interfaces, sensors, communication protocol, and the like.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The automated sandwich system will preferably include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using the compiler.

In one embodiment, the software application and the compiler are tangibly embodied in the computer-readable medium. When the instructions are read and executed by the non-transitory computer readable medium, the non-transitory computer readable medium performs the steps necessary to implement and/or use the present invention. A software application, operating instructions, and/or firmware (semi-permanent software programmed into read-only memory) may also be tangibly embodied in the memory and/or data communication devices, thereby making the software application a product or article of manufacture according to the present invention.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

The power supply outputs a particular voltage to a device or component or components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (“LSD-NiMH”) battery, a nickel-cadmium battery (“NiCd”), a lithium-ion battery, or a lithium-ion polymer (“LiPo”) battery

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

The sensors sense one or more characteristics of an object and can include, for example, accelerometers, position sensors, pressure sensors (including weight sensors), or fluid level sensors among many others. The accelerometers can sense acceleration of an object in a variety of directions (e.g., an x-direction, a y-direction, etc.). The position sensors can sense the position of one or more components of an object. For example, the position sensors can sense the position of an object relative to another fixed object such as a wall. Pressure sensors can sense the pressure of a gas or a liquid or even the weight of an object. The fluid level sensors can sense a measurement of fluid contained in a container or the depth of a fluid in its natural form such as water in a river or a lake. Fewer or more sensors can be provided as desired. For example, a rotational sensor can be used to detect speed(s) of object(s), a photodetector can be used to detect light or other electromagnetic radiation, a distance sensor can be used to detect the distance an object has traveled, a timer can be used for detecting a length of time an object has been used and/or the length of time any component has been used, and a temperature sensor can be used to detect the temperature of an object or fluid.

Furthermore, any of the information related to the system, such as inputs, sensed data, conditions, status, programming, or the like could be communicated, such as via a user interface, either in person or remotely. In such a remote configuration, communication protocols could be used. In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

Therefore, the invention has been described to show the assembly and packaging of a submarine sandwich in a fully automated manner. As the specifics of the rolls to create the submarine sandwiches are different and difficult, it will be readily apparent the system provides numerous improvements and/or advantages.

As would be apparent to one of ordinary skill in the art, mechanical, procedural, or other changes/modifications may be made without departing from the spirit and scope of the invention. The scope of the invention is defined only by the appended claims, along with the full scope of equivalents to which such claims are entitled.

1. An automated submarine sandwich assembly method, the method comprising:
slicing, with an automated slicer, a piece of bread into a top portion and a bottom portion;
moving the top portion and the bottom portion of the bread via an automated conveyor;
adding, with an automated picker robot, one or more inputs to the top or bottom portion of the bread, wherein the one or more inputs comprise sandwich components to create an assembled sandwich;
moving the assembled sandwich, via the automated conveyor, to an automated packaging system; and
packaging, via the automated packaging system, the assembled sandwich.

2. The automated method of claim 1, further comprising placing the top portion of the bread on the bottom portion and one or more inputs to assemble the assembled sandwich before moving the assembled sandwich to the automated packaging system.

3. The automated method of claim 2, wherein the step of placing the top portion of the bread on the bottom portion and one or more inputs comprises using an automated picker robot to pick the top portion of the bread and to place it on the bottom portion and one or more inputs.

4. The automated method of claim 1, further comprising sensing, with one or more sensors, a quality control of the assembled sandwich before moving the assembled sandwich to the automated packaging system.

5. The automated method of claim 4, further comprising redirecting a rejected assembled sandwich that does not meet the quality control sensed by the sensor to a reject line that bypasses the automated packaging system.

6. The automated method of claim 5, further comprising, reintroducing the rejected assembled sandwich to the automated conveyor after the quality has been corrected.

7. The automated method of claim 1, wherein the automated slicer comprises an ultrasonic bread slicer.

8. The automated method of claim 1, wherein the automated conveyor comprises a pin conveyor.

9. The automated method of claim 1, further comprising adding one or more condiments into the packaging of the assembled sandwich to create a packaged sandwich and condiments.

10. The automated method of claim 9, further comprising placing the packaged sandwich and condiments into a container with an automated picker robot.

11. The automated method of claim 1, wherein the one or more inputs comprise meats, cheeses, vegetables, fruits, condiments, or the like.

12. An automated system for assembling and packaging a submarine sandwich, comprising:
an automated slicer for slicing a bread into a top portion and a bottom portion;
an automated picker robot for placing one or more inputs onto the top portion or bottom portion of the sliced bread;
an automated assembler robot for combining the top and bottom bread portions and the one or more inputs to create an assembled sandwich;
an automated packaging system comprising a picker for placing the assembled sandwich into packaging and closing the packaging; and
an automated conveyor between each of the automated slicer, automated picker robot, automated assembler robot, and automated packaging system to move the components therebetween.

13. The system of claim 12, further comprising one or quality control sensor to sense the quality of the automated system and sandwich components moving therethrough.

14. The system of claim 12, further comprising a plurality of input locations storing the one or more inputs.

15. The system of claim 14, wherein the one or more inputs comprise meats, cheeses, vegetables, fruits, condiments, utensils, or the like.

16. The system of claim 12, wherein the automated slicer comprises an ultrasonic bread slicer.

17. The system of claim 12, wherein the automated conveyor comprises a pin conveyor.

18. A method of automatedly assembling and packaging a submarine sandwich, the method comprising:
slicing, with an automated slicer, a piece of cylindrical bread;
moving the sliced piece of bread via an automated conveyor;
adding, with an automated picker robot, one or more inputs to the sliced bread, wherein the one or more inputs comprise sandwich components to create an assembled sandwich;
moving the assembled sandwich, via the automated conveyor, to an automated packaging system; and
placing the assembled sandwich into a packaging with one or more condiments or utensils and sealing the packaging.

19. The method of claim 18, further comprising determining via a set of electronic instructions, a type of submarine sandwich to assemble using a combination of the one or more inputs.

20. The method of claim 19, wherein the set of electronic instructions are stored in an electronic database.
